(19) United States
(12) Patent Application Publication
(10) Pub. No.: US 2009/0227149 A1
(43) Pub. Date: Sep. 10, 2009

(54) ELECTRICAL CARD CONNECTOR WITH IMPROVED CONTACTS

(75) Inventors: Zhong-Jun Ma, ShenZhen (CN); Nan Hu, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/317,404

(22) Filed: Dec. 22, 2008

(30) Foreign Application Priority Data
Mar. 5, 2008 (CN) 200820032482.9

(51) Int. Cl. H01R 9/00

(52) U.S. Cl. 439/658

(57) ABSTRACT

An electrical card connector (100), assembled on a printed circuit board (PCB), includes an insulating housing (1) and a plurality of contacts (3) received in the insulating housing. The insulating housing defines a plurality of receiving channels (12) and a plurality of fixing channels (11). Each contact includes a base portion (31), a contact portion (33) cantilevered above the base portion and partially received in the receiving channel, and a pair of fixing portions (34) respectively at two lateral sides of the base portion and received in corresponding fixing channels.

### BACKGROUND OF THE INVENTION

1. Field of the Invention

The present invention relates generally to electrical card connectors, and more particularly to an electrical card connector with improved contacts.

2. Description of Related Arts

IC cards have been developed and a type of IC card called a subscriber identification module card (SIM card) is used in cellular phones as an identification and storage unit for subscriber related data. A SIM card normally includes a terminal array for connection through a card connector to the external equipment. The connector usually includes a card socket for receiving the SIM card and a plurality of resilient contacts for engaging the terminal array of the card when the card is inserted into the socket.

A conventional electrical card connector forms a plurality of conventional contacts and an insulating housing. Each contact comprises a flat main portion with a plurality of spinous portions extending along a latitudinal direction, a contact portion for contacting with the terminal array of the card, a flexible connecting portion connecting the contacting portion with the flat main portion and a rail portion extending from the flat main portion and soldered with a circuit board. The insulating housing defines a plurality of receiving channels for receiving the flat main portions and forms a plurality of fixing portions extending along a latitudinal direction for interfering with the spinous portions in a horizontal direction, so that the contacts are fixed in the insulating housing. Accompanying with a minimization of the electric product, it is more and more difficult to define receiving channels in the insulating housing with fixing portions, which extend along a latitudinal direction; when the card is inserted, the contact portion is pressed by the card, the fixing portions and the edges of the insulating housing adjacent to the receiving channels are easy to be destroyed by the contacts and then, the contacts may drop off from the receiving channels, the electrical performance of the card connector is not effectively achieved.

Hence, an improved electrical card connector is desired.

### SUMMARY OF THE INVENTION

Accordingly, an object of the present invention is to provide an electrical card connector with improved contacts.

To achieve the above object, an electrical card connector, assembled on a printed circuit board (PCB), includes an insulating housing and a plurality of contacts received in the insulating housing. The insulating housing defines a plurality of receiving channels and a plurality of fixing channels. Each contact includes a base portion, a contact portion cantilevered above the base portion and partially received in the receiving channel, and a pair of fixing portions respectively at two lateral sides of the base portion and received in corresponding fixing channels.

Other objects, advantages and novel features of the invention will become more apparent from the following detailed description when taken in conjunction with the accompanying drawings.

### BRIEF DESCRIPTION OF THE DRAWING

FIG. 1 is a perspective, assembled view of an electrical card connector according to the present invention;

FIG. 2 is a perspective, exploded view of the electrical card connector; and

FIG. 3 is a perspective view of the contact.

### DETAILED DESCRIPTION OF THE PREFERRED EMBODIMENT

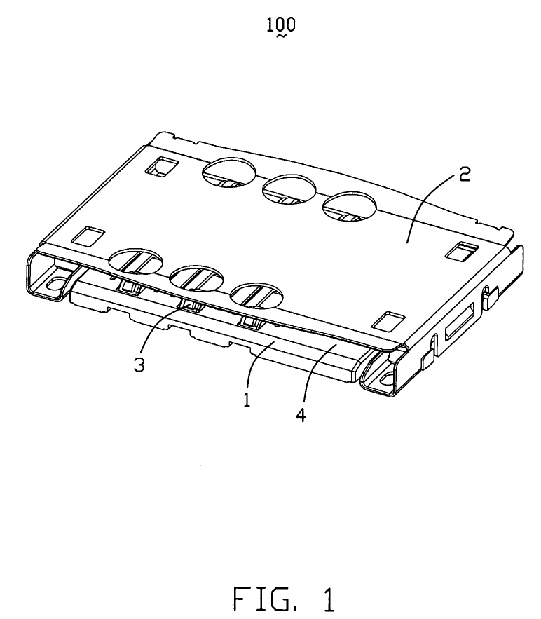

FIGS. 1-3 illustrate an electrical card connector 100 in accordance with the present invention, assembled on a printed circuit board (PCB) (not shown) and comprising an insulating housing 1, a plurality of contacts 3 received in the insulating housing 1, a metal shield 2 shielding over the insulating housing 1 for defining a card receiving space 4.

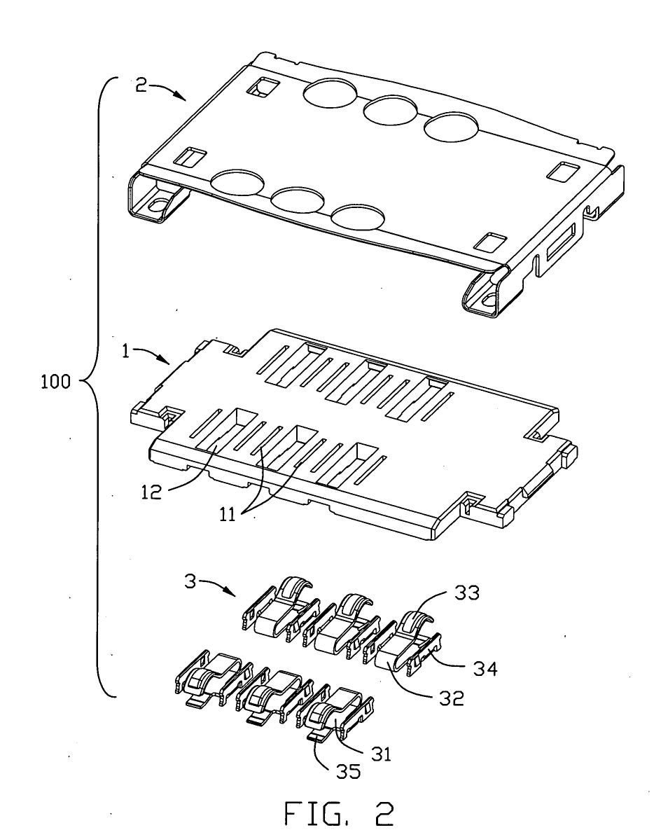

Referring to FIG. 2, the insulating housing 1, generally rectangular shaped, defines a plurality of receiving channels 12 respectively and correspondingly arranged in two parallel lines and also defines two fixing channels 11 sandwiching each receiving channel 12. The receiving channel 12 is wider and longer than the fixing channel 11 in size. Both the receiving channels 12 and the fixing channels 11 extend through an upper side and a lower side of the insulating housing 1. The lengthwise receiving channel 12 and the lengthwise fixing channel 11 extend along a card insertion/ejection direction perpendicular to a direction defined by the parallel lines.

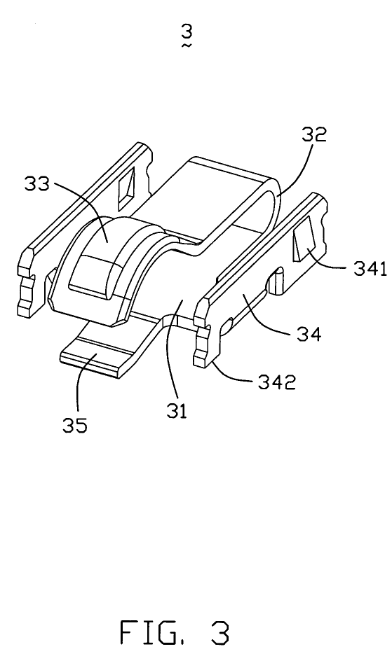

Referring to FIGS. 2-3, the contacts 3 are divided into two groups which are retained in the insulating housing 1, respectively. Each contact 3 comprises a base portion 31, a contact portion 33 shaped as an arch, a U-shaped connecting portion 32 connecting the contact portion 33 with the base portion 31 and a rail portion 35 extending from a free end of the base portion 31 opposite to the U-shaped connecting portion 31. The contact portion 33 is just above the base portion 31 for electrically contacting with a SIM card (not shown). Each contact 3 further forms a pair of fixing portions 34 respectively at two lateral sides thereof. The fixing portions 34 extend vertically and upwardly from two edges of the base portion 31. Each fixing portion 34 forms a taper portion 341 with a width gradually decreased from a bottom face to a top face. The fixing portion 34 has elasticity and can be elastically pressed in a certain scope. The fixing portion 34 further forms a supporting pole 342 downwardly extending and adjacent to the rail portion 35, for one purpose to be soldered with the PCB and for another purpose to support the whole contact 3 on the insulating housing 1 so as to prevent the contact 3 from dropping off from the insulating housing 1. The rail portion 35 is laid on the PCB for preventing the contact 3 from concentrating excessive pressure on the supporting pole 342.

In assembly, the contact 3 is inserted into the insulating housing 1 along a down-to-up direction, the taper portion 341 goes through the fixing channel 11 and presses against the insulating housing 1 due to the elasticity thereof. Accordingly, the fixing portion 34 is received in the fixing channel 11. The contact portion 33 is partially received in the corresponding receiving channel 12 and partially exposed into the card receiving space 4. Because of the flexibility of the U-shaped connecting portion 32, the contact portion 33 can be pressed and the receiving channel 12 provides a space for a movement of the contact portion 33.

In the present invention, for the fixing portion 34 extends along a vertical direction and is received in the fixing channels 11 under a condition of the taper portion 341 engaging the insulating housing 1, hence, the contact 3 is fixedly engaged with the insulating housing 1 and is not easy to fall down from the insulating housing 1. The supporting portion 342 distracts pressure on the supporting 342 generated by the contact's own weight and the card's insertion.

While a preferred embodiment in accordance with the present invention has been shown and described, equivalent modifications and changes known to persons skilled in the art according to the spirit of the present invention are considered within the scope of the present invention as described in the appended claims.

We claim:

1. An electrical card connector, assembled on a printed circuit board (PCB), comprising:
an insulating housing defining a plurality of receiving channels and a plurality of fixing channels; and
a plurality of contacts received in the insulating housing, each contact comprising a base portion, a contact portion cantilevered above the base portion and partially received in the receiving channel, and a pair of fixing portions respectively at two lateral sides of the base portion and received in corresponding fixing channels.

2. The electrical card connector as described in claim 1, wherein the fixing portions extend vertically and upwardly from two edges of the base portion.

3. The electrical card connector as described in claim 2, wherein the fixing portion forms a taper portion engaging with the insulating housing.

4. The electrical card connector as described in claim 3, wherein the taper portion has a width gradually decreased from a bottom face to a top face.

5. The electrical card connector as described in claim 2, wherein the fixing portion forms a supporting pole soldered with the PCB.

6. The electrical card connector as described in claim 5, wherein the contact comprises a rail portion connecting with the base portion.

7. The electrical card connector as described in claim 6, wherein the rail portion is laid on the PCB.

8. The electrical card connector as described in claim 6, wherein the supporting pole is adjacent to the rail portion.

9. The electrical card connector as described in claim 3, wherein both the receiving channels and the fixing channels extend through an upper side and a lower side of the insulating housing.

10. The electrical card connector as described in claim 9, wherein the receiving channel is wider and longer than the fixing channel in size.

11. The electrical card connector as described in claim 10, wherein two fixing channels sandwich each receiving channel.

12. The electrical card connector as described in claim 11, wherein the receiving channels are arranged in two parallel lines.

13. The electrical card connector as described in claim 12, wherein both the lengthwise receiving channel and the lengthwise fixing channel extend along a direction perpendicular to a direction defined by the parallel lines.

14. An electrical card connector comprising:
an insulative housing defining a main passageway and a pair of retention channels by two sides of the main passageway;
a contact upwardly assembled to the housing and including a base defining four sides thereof, a solder tail extending from one of said four sides, a pair of retention sections extending other two opposite sides of said four sides and inserted into the corresponding retention channel, and a contact arm extending from another side of said four sides into the main passageway; wherein
the retention section includes a first retention device protruding in a first plane defined by said retention section, and a second retention device protruding in a second plane perpendicular to said first plane.
